(19) United States
(12) Patent Application Publication
(10) Pub. No.: US 2005/0258624 A1
(43) Pub. Date: Nov. 24, 2005

(54) Vehicle seat having inflatable cushion deployment

(76) Inventors: Brian L. Abraham, Fairborn, OH (US); Rebecca A. Bevak, Monroe, OH (US); Margaret A. Fisher, Huber Heights, OH (US); Michelle L. Frank, Miamisburg, OH (US)

Correspondence Address: Scott A. McBain, ESQ.;DELPHI TECHNOLOGIES, INC., P.O. Box 5052, Mail Code: 480-414-420, Troy, MI, 48007-5052, US

(21) Appl. No.: 10/851,397

(22) Filed: May 21, 2004

(51) Int. Cl. B60R 21/20; B60R 21/22

(52) U.S. Cl. 280/728.3; 280/730.2

(57) ABSTRACT

A vehicle seat in accordance with an exemplary embodiment is provided. The vehicle seat includes an air bag module coupled to a vehicle seat frame, the air bag module having an inflatable cushion. The vehicle seat further includes a seat cover configured to cover at least a portion of the air bag module. The seat cover has a deployment opening defining a first edge and a second edge adjacent the first edge. The vehicle seat further includes first and second interlocking members attached to the seat cover proximate the first and second edges, respectively. The first interlocking member is configured to interlock with the second interlocking member to thereby close the deployment opening. The first and second interlocking members extend substantially an entire length of the first and second edges. The first and second interlocking members disengage from one another upon deployment of the inflatable cushion to allow the inflatable cushion to pass through the deployment opening.

### TECHNICAL FIELD

The present application relates to a vehicle seat having a seat cover for allowing an inflatable cushion to be deployed therethrough.

### BACKGROUND

Air bag modules have been incorporated into vehicle seats. In particular, the air bag modules are mounted to a seat frame and are covered by a seat cover. In general, an air bag module contains an inflatable cushion that deploys through the seat cover when it is inflated by an inflator of the air bag module.

A vehicle seat having air bag module also has a seat cover that surrounds a seat frame and the air bag module. The seat cover generally has a deployment opening that is closed by stitching two edges of the seat cover together using thread. Manufacturers of vehicle seat covers utilize various types of thread and stitching patterns to close the deployment opening. As a result the various methodologies for closing the deployment opening, vehicle seat manufacturers perform numerous functional tests on each seat cover having a particular type of thread and stitching pattern, to ensure proper deployment of an inflatable cushion. Further, since each vehicle model can have a plurality of seat covers, a substantial number of functional tests are preformed.

Thus, it would be desirable to have a seat having a seat cover that has a standardized closing means for closing a deployment opening.

### SUMMARY

A vehicle seat in accordance with an exemplary embodiment is provided. The vehicle seat includes an air bag module coupled to a vehicle seat frame, the air bag module having an inflatable cushion. The vehicle seat further includes a seat cover configured to cover at least a portion of the air bag module. The seat cover has a deployment opening defining a first edge and a second edge adjacent the first edge. The vehicle seat further includes first and second interlocking members attached to the seat cover proximate the first and second edges, respectively. The first interlocking member is configured to interlock with the second interlocking member to thereby close the deployment opening. The first and second interlocking members extend substantially an entire length of the first and second edges. The first and second interlocking members disengage from one another upon deployment of the inflatable cushion to allow the inflatable cushion to pass through the deployment opening.

A vehicle seat in accordance with an exemplary embodiment is provided. The vehicle seat includes an air bag module coupled to a vehicle seat frame, the air bag module having an inflatable cushion. The vehicle seat further includes a seat cover configured to cover at least a portion of the air bag module. The seat cover has a deployment opening defining a first edge and a second edge adjacent the first edge. The vehicle seat further includes first and second interlocking members attached to the seat cover proximate the first and second edges, respectively. The first interlocking member has a first hook portion and the second interlocking member has a second hook portion. The first hook portion is configured to interlock with the second hook portion to thereby close the deployment opening. The first and second hook portions disengage from one another upon deployment of the inflatable cushion to allow the inflatable cushion to pass through the deployment opening.

A vehicle seat in accordance with another exemplary embodiment is provided. The vehicle seat includes an air bag module coupled to a vehicle seat frame. The air bag module has an inflatable cushion. The vehicle seat further includes a seat cover configured to cover at least a portion of the air bag module. The seat cover has a deployment opening defining a first edge and a second edge adjacent the first edge. The vehicle seat further includes first and second interlocking members attached to the seat cover proximate the first and second edges, respectively. The first interlocking member has at least one generally C-shaped receiving portion and the second interlocking member having at least one tab configured to be received and held within an interior of the receiving portion to thereby close the deployment opening. The receiving portion and the tab disengage from one another upon deployment of the inflatable cushion to allow the inflatable cushion to pass through the deployment opening.

A vehicle seat of accordance with another exemplary embodiment is provided. The vehicle seat includes an air bag module coupled to a vehicle seat frame, the air bag module having an inflatable cushion. The vehicle seat further includes a seat cover configured to cover at least a portion of the air bag module. The seat cover has a deployment opening defining a first edge and a second edge adjacent the first edge. A vehicle seat further includes at least one plastic fastener attached to the seat cover proximate the first edge and further attached to the seat cover proximate the second edge to close the deployment opening. The at least one plastic fastener breaks upon deployment of the inflatable cushion to allow the inflatable cushion to pass through the deployment opening.

A flexible enclosure in accordance with another exemplary embodiment is provided. The flexible enclosure includes a cover having a deployment opening defining a first edge and a second edge adjacent the first edge. The flexible enclosure further includes first and second interlocking members attached to the cover proximate the first and second edges, respectively. The first interlocking member is configured to interlock with the second interlocking member to thereby close the deployment opening of the cover. The first and second interlocking members extend substantially an entire length of the first and second edges. The first and second interlocking members disengage from one another in response to an opening force being applied to the cover to open the deployment opening.

A flexible enclosure in accordance with another exemplary embodiment is provided. The flexible enclosure includes a cover having a deployment opening defining a first edge and a second edge adjacent the first edge. The flexible enclosure further includes first and second interlocking members attached to the cover proximate the first and second edges, respectively. The first interlocking member has a first hook portion and the second interlocking member has a second hook portion. The first hook portion is configured to interlock with the second hook portion to thereby close the deployment opening. The first and second hook portions disengage from one another in response to an opening force being applied to the cover to open the deployment opening.

A flexible enclosure in accordance with another exemplary embodiment is provided. The flexible closure includes a cover having a deployment opening defining a first edge and a second edge adjacent the first edge. The flexible closer further includes first and second interlocking members attached to the seat cover proximate the first and second edges, respectively. The first interlocking member has at least one generally C-shaped receiving portion and the second interlocking member having at least one tab configured to be received and held within an interior of the receiving portion to thereby close the deployment opening. The receiving portion and the tab disengage from one another in response to an opening force being applied to the cover to open the deployment opening.

A flexible enclosure in accordance with another exemplary embodiment is provided. The flexible enclosure includes a cover having a deployment opening defining a first edge and a second edge adjacent the first edge. The flexible enclosure further includes at least one plastic fastener attached to the cover proximate the first edge and further attached to the cover proximate the second edge to close the deployment opening of the cover. The at least one plastic fastener breaks in response to an opening force being applied to the cover to open the deployment opening.

A flexible enclosure in accordance with another exemplary embodiment is provided. The flexible enclosure includes a cover having a deployment opening defining a first edge and a second edge adjacent the first edge. The flexible enclosure further includes first and second fastening means attached to the cover proximate the first and second edges, respectively, for closing the deployment opening. The first and second fastening means extend substantially an entire length of the first and second edges. The first and second fastening means are configured to engage one another when the inflatable cushion is in a non-inflated state. The first and second fastening means are configured to disengage from one another in response to an opening force being applied to the cover to open the deployment opening.

A method for testing deployment of an inflatable cushion through a cover in accordance with exemplary embodiment is provided. The cover has a deployment opening defining a first edge and a second edge adjacent the first edge. The method includes interlocking first and second interlocking members to one another to close the deployment opening. The first and second interlocking members are attached to the cover proximate the first and second edges, respectively, and extend substantially an entire length of the first and second edges. Finally, the method includes inflating the inflatable cushion to apply an opening force to the cover to induce the first and second interlocking members to disengage from one another to open the deployment opening.

A method for testing deployment of an inflatable cushion through a cover in accordance with another exemplary embodiment is provided. The cover has a deployment opening defining a first edge and a second edge adjacent the first edge. The method includes interlocking first and second hook portions to one another to close the deployment opening. The first and second hook portions are attached to the cover proximate the first and second edges, respectively. Finally, the method includes inflating the inflatable cushion to apply an opening force to the cover to induce the first and second interlocking members to disengage from one another to open the deployment opening.

A method for testing deployment of an inflatable cushion through a cover in accordance with another exemplary embodiment is provided. The cover has a deployment opening defining a first edge and a second edge adjacent the first edge. The method includes interlocking a generally C-shaped receiving portion and a tab to one another to close the deployment opening. The receiving portion and the tab are attached to the cover proximate the first and second edges, respectively. Finally, the method includes inflating the inflatable cushion to apply an opening force to the cover to induce the receiving portion and the tab to disengage from one another to open the deployment opening.

A method for testing deployment of an inflatable cushion through a cover in accordance with another exemplary embodiment is provided. The cover has a deployment opening defining a first edge and a second edge adjacent the first edge. The method includes attaching at least one plastic fastener to the cover proximate the first edge and to the cover proximate the second edge to close the deployment opening. Finally, method includes inflating the inflatable cushion to apply an opening force to the cover to break the plastic fastener to open the deployment opening.

### BRIEF DESCRIPTION OF THE DRAWINGS

FIG. 1 is a perspective view of a vehicle seat having an air bag module disposed therein;

FIG. 2 is a perspective view of the vehicle seat of FIG. 1 having a deployed inflatable cushion;

FIG. 3 is a perspective view of the vehicle seat of FIG. 1 illustrating an air bag module disposed therein;

FIG. 4 is an enlarged sectional view of an embodiment of a seat cover of the vehicle seat of FIG. 1;

FIG. 5 is an enlarged view of a portion of the seat cover of FIG. 4;

FIG. 6 is a view the seat cover of FIG. 4 showing a deployment opening;

FIG. 7 is an enlarged sectional view of another exemplary embodiment of a seat cover;

FIG. 8 is an enlarged sectional view of another exemplary embodiment of a seat cover;

FIGS. 9 and 10 are enlarged sectional views of an exemplary embodiment of first and second interlocking members used in the seat cover of FIG. 8;

FIGS. 11 and 12 are enlarged sectional views of another exemplary embodiment of first and second interlocking members that can be used in the seat cover of FIG. 8;

FIG. 13 is an enlarged sectional view of another exemplary embodiment of a seat cover;

FIG. 14 is an enlarged sectional view of another exemplary embodiment of a seat cover;

FIGS. 15, 16, and 17 are enlarged sectional views of an exemplary embodiment of first and second interlocking members used in the seat cover of FIG. 14;

FIG. 18 is an enlarged sectional view of another exemplary embodiment of a seat cover;

FIG. 19 is an enlarged sectional view of another exemplary embodiment of a seat cover;

FIG. 20 is an enlarged sectional view of first and second interlocking members used in the seat cover of FIG. 19;

FIG. 21 is an enlarged sectional view of another exemplary embodiment of a seat cover;

FIG. 22 is in enlarged sectional view of a fastening member used in the seat cover of FIG. 21;

FIG. 23 is an enlarged sectional view of another exemplary embodiment of a seat cover;

FIG. 24 is in enlarged cross-sectional view of a fastening member used in the seat cover of FIG. 23;

FIGS. 25 and 26 are top views of a system for testing a seat cover;

FIG. 27 is a flowchart of a method for testing the seat covers of FIGS. 4 and 19 in accordance with another exemplary embodiment;

FIG. 28 is a flowchart of another method for testing the seat cover of FIG. 14 in accordance with another exemplary embodiment;

FIG. 29 is a flowchart of another method for testing the seat cover of FIG. 8 in accordance with another exemplary embodiment; and

FIG. 30 is a flowchart of another method for testing the seat cover of FIGS. 21 and 23 in accordance with another exemplary embodiment;

### DETAILED DESCRIPTION OF EXEMPLARY EMBODIMENTS

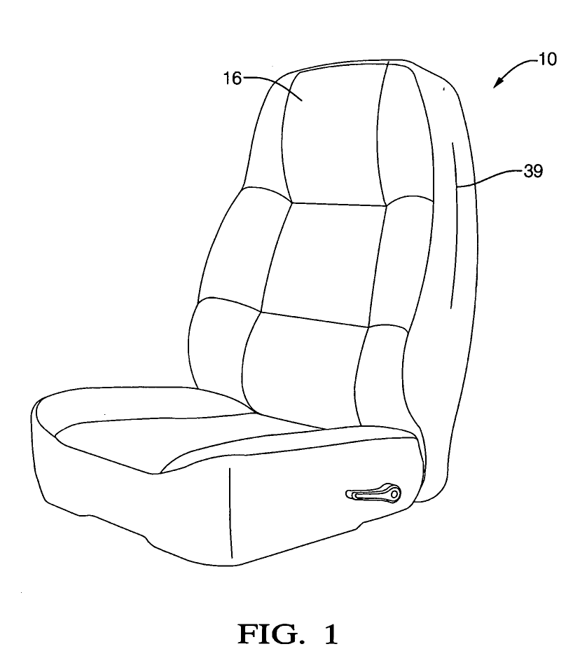

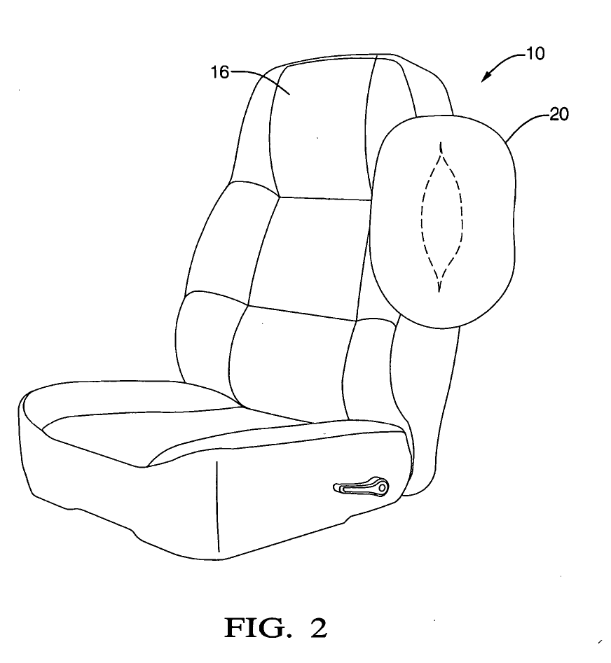

Referring now to FIGS. 1, 2, and 3, a vehicle seat 10 is illustrated that can be utilized in a car or truck (not shown). The seat 10 includes a frame 12 and an air bag module 14 attached to the frame 12. A seat cover or flexible enclosure 16 is utilized to cover the frame 12 and the air bag module 14. During activation of the air bag module 14, an inflatable cushion 20 is inflated to induce an opening force against a deployment opening in the seat cover 16, to deploy the cushion 20 through the deployment opening.

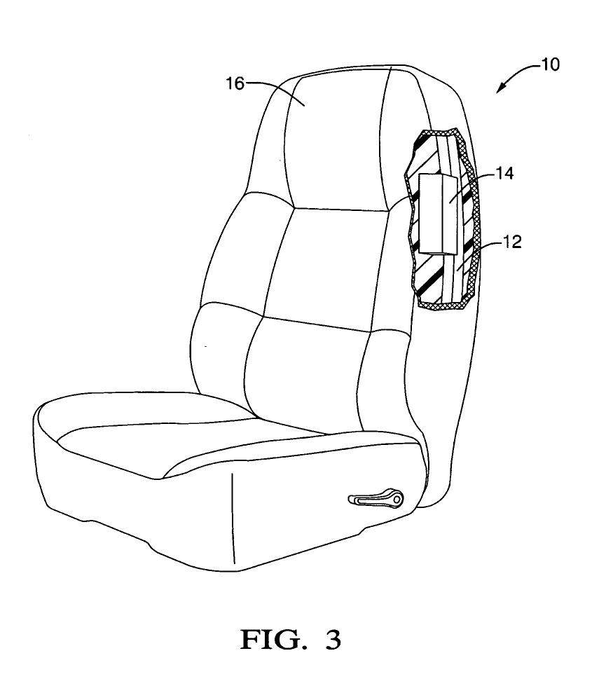

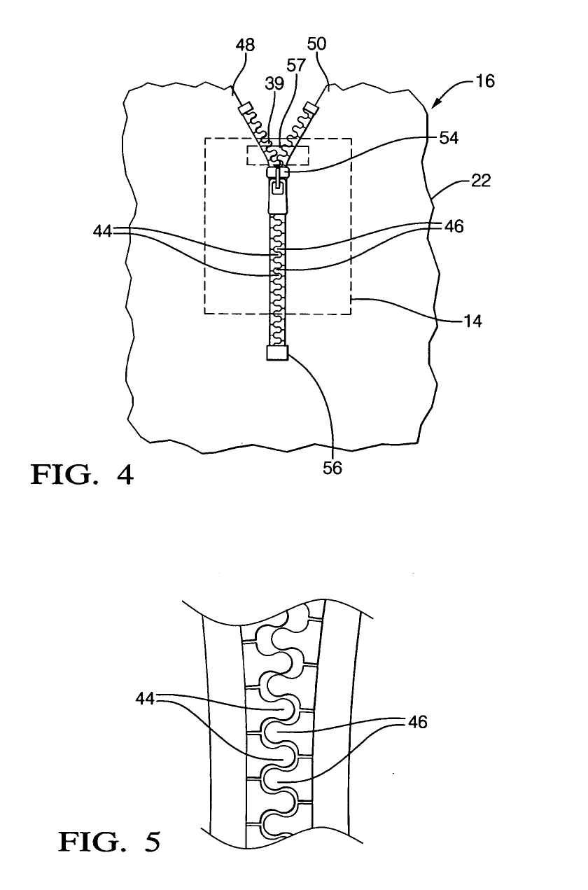

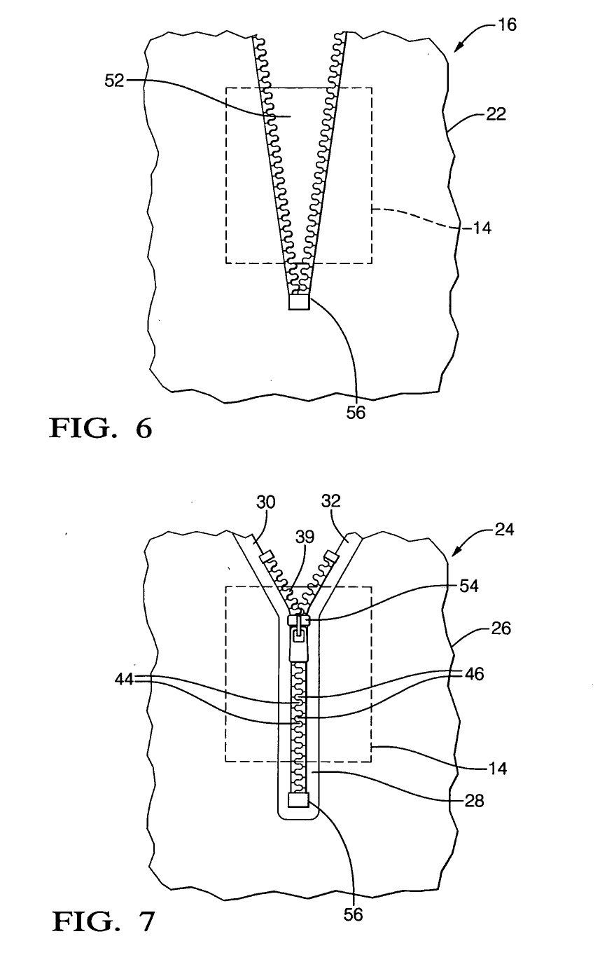

Referring to FIGS. 4, 5, and 6, the seat cover 16 will now be described in greater detail. The seat cover 16 can be constructed from one or more materials including for example: nylon, polyester, leather, and cloth, or a combination thereof. The seat cover 16 includes a portion 22 having a seam or a slit 39 that extends through portion 22 proximate the air bag module 14. When the seam 39 is in an open position, the seam 39 defines a deployment opening 52 for allowing the inflatable cushion 20 from the air bag module 14 to extend therethrough. In order to close the seam 39, first and second interlocking members are utilized. The first interlocking member comprises a plurality of zipper teeth 44 coupled to the portion 22 proximate an edge 48. The second interlocking member comprises a plurality of zipper teeth 46 coupled to the portion 22 proximate an edge 50. The plurality of zipper teeth 44 and the plurality of zipper teeth 46 can be constructed from aluminum, brass, steel molded plastic, or nylon.

The plurality of zipper teeth 44 are interlocked with the plurality of zipper teeth 46 using a slider 54 that urges each zipper tooth 44 adjacent a corresponding zipper tooth 46. The plurality of zipper teeth 44 and the plurality of zipper teeth 46 are configured such that teeth 44 and teeth 46 disengage from one another when the inflatable cushion 20 pushes against seam 39 during deployment of the inflatable cushion 20. In particular, the plurality of zipper teeth 44 and the plurality of zipper teeth 46 are configured to disengage from one another in response to a predetermined pressure being applied to the seam 39 by the inflatable cushion 20. Further, in alternate embodiments the spacing between zipper teeth 44, 46 and the shape of the zipper teeth 44, 46 can vary based upon a desired force for disengaging the zipper teeth 44 and zipper teeth 46 from one another. When zipper teeth 44 and zipper teeth 46 disengage from one another during deployment of the inflatable cushion 20, a deployment opening 52 allows inflatable cushion 20 to pass therethrough. The plurality of zipper teeth 44 and the plurality of zipper teeth 46 can be constructed from aluminum, brass, steel, molded plastic, or nylon. Further, a portion of adhesive tape 57 can be placed over the zipper teeth 44 and 46 to prevent the slider 54 from inadvertently separating the zipper teeth 44 and 46 when air bag module 14 is not being activated.

Referring to FIG. 7, a seat cover 24 in accordance with another exemplary embodiment will be described. The seat cover 24 is similar to the seat cover 16, except that the seat cover 24 includes a portion 28 for holding and supporting the zipper teeth 44 and 46. The portion 28 includes edges 30 and 32 that define a deployment opening for the inflatable cushion 20. Further, the portion 28 is stitched to a portion 26 of the seat cover 24.

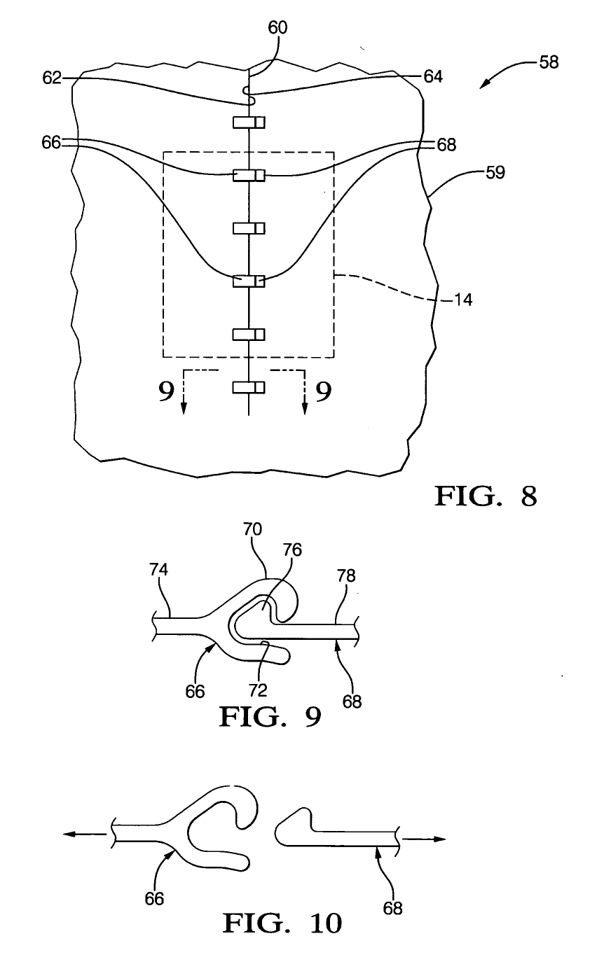

Referring to FIGS. 8, 9, and 10, a seat cover 58 in accordance with another exemplary embodiment will now be described. The seat cover 58 includes a portion 59 having a seam or a slit 60 that extends through portion 59 proximate the air bag module 14. When the seam 60 is an open position, seam 60 defines a deployment opening for allowing the inflatable cushion 20 from the air bag module 14 to extend therethrough. In order to close the seam 60, the seat cover 58 includes first and second interlocking members. The first interlocking member comprises a plurality of receiving portions 66 coupled to the portion 59 proximate a first edge 62. The second interlocking member comprises a plurality of tabs 68 coupled to the portion 59 proximate a second edge 64. The plurality of receiving portions 66 can be coupled or interlocked to the plurality of tabs 68 manually. Alternately, portions 66 and tabs 68 can be coupled together using automated equipment.

Each of the receiving portions 66 includes a C-shaped portion 70 attached to a shaft portion 74. The C-shaped portion 70 defines an interior region 72 configured to receive the tab 68. The shaft portion 74 is coupled to the seat cover 58 proximate the first edge 62. The tab 68 includes a head portion 76 coupled to a shaft portion 78. The head portion 76 is configured to be received and to be fixedly held within the interior region 72 of a corresponding receiving portion 66. The shaft portion 78 is coupled to the portion 59 proximate the second edge 64.

The plurality of receiving portions 66 and a plurality of tabs 68 are configured such that receiving portions 66 and tabs 68 will disengage from one another when the inflatable cushion 20 pushes against seam 60 during deployment of the inflatable cushion 20. In particular, when inflatable cushion 20 presses against seam 60 at a predetermined pressure during deployment of the inflatable cushion 20, each head portion 76 will move out of an interior region 72 of a corresponding receiving portion 66. When the receiving portions 66 and the tabs 68 disengage from one another, the seam 60 defines a deployment opening that allows inflatable cushion 20 to pass therethrough.

The plurality of receiving portions 66 and the plurality of tab portions 68 can be constructed from aluminum, brass, steel, molded plastic, or nylon, for example. Further, it should be noted that: (i) the number of receiving portions 66 and tab portions 68 can vary, (ii) the placement of the receiving portions 66 and tab portions 68 on seat cover 58 can vary, and (iii) the size of the receiving portions 66 and tab portions 68 can vary, based upon the desired opening characteristics of the seam 60.

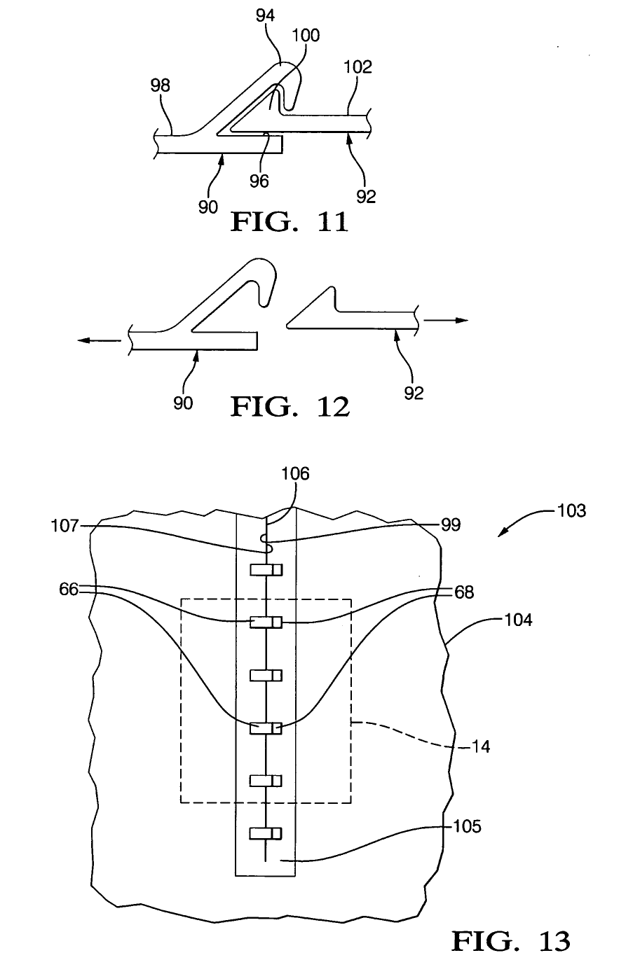

Referring to FIGS. 8, 11, and 12, an alternate design for the plurality of receiving members and the plurality of tabs that can be utilized with portion 59, are illustrated. A receiving portion 90 includes a latching portion 94 and a shaft portion 98 coupled to the latching portion 94. The latching portion 94 defines an interior region 96 configured to receive a corresponding tab 92. The shaft portion 98 is coupled to the portion 59 proximate the first edge 62. The tab 92 includes a barb-shaped head portion 100 coupled to a shaft portion 102. The barb-shaped head portion 100 is configured to be received and to be fixedly held within the interior region 96 of the corresponding receiving portion 90. The shaft portion 102 is coupled to the portion 59 proximate the second edge 64. Like the receiving portions 66 and tabs 68 discussed above, the plurality of receiving portions 90 and tabs 92 are configured to disengage from one another in response to a predetermined pressure being applied to the seam 60 by the inflatable cushion 20. The receiving portions 90 and the tab portions 92 can be constructed from aluminum, brass, steel, molded plastic, or nylon, for example.

Referring to FIG. 13, a seat cover 103 in accordance with another exemplary embodiment will be described. The seat cover 103 is similar to the seat cover 58, except that the seat cover 103 includes a portion 105 for holding and supporting the receiving portions 66 and the tabs 68. The portion 105 includes edges 107 and 99 that define a deployment opening for the inflatable cushion 20. Further, the portion 105 is stitched to a portion 104 of the seat cover 103. Further, in an alternate embodiment, the seat cover 103 can utilize receiving portions 90 and tabs 92, instead of receiving portions 66 and tabs 68.

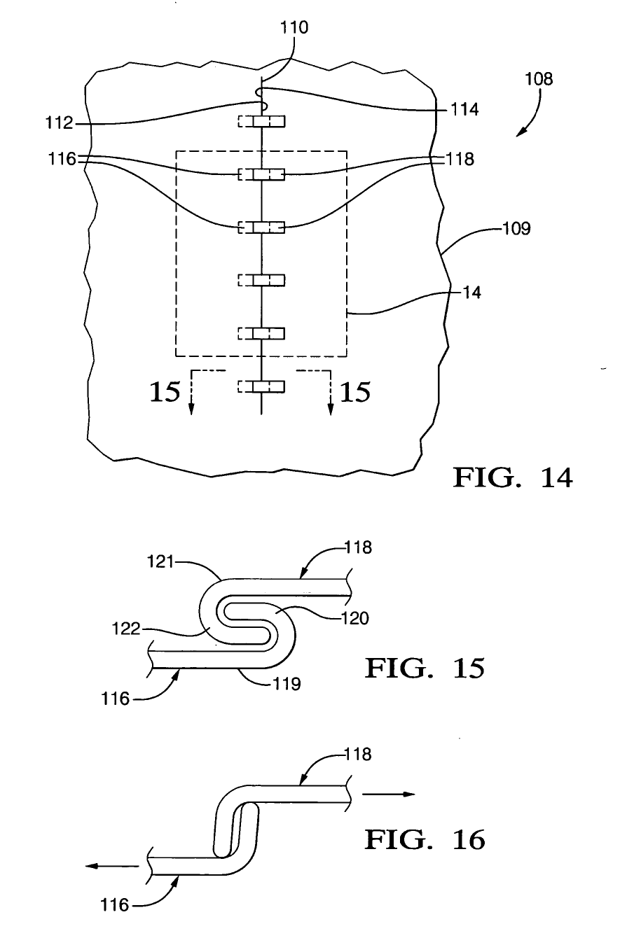

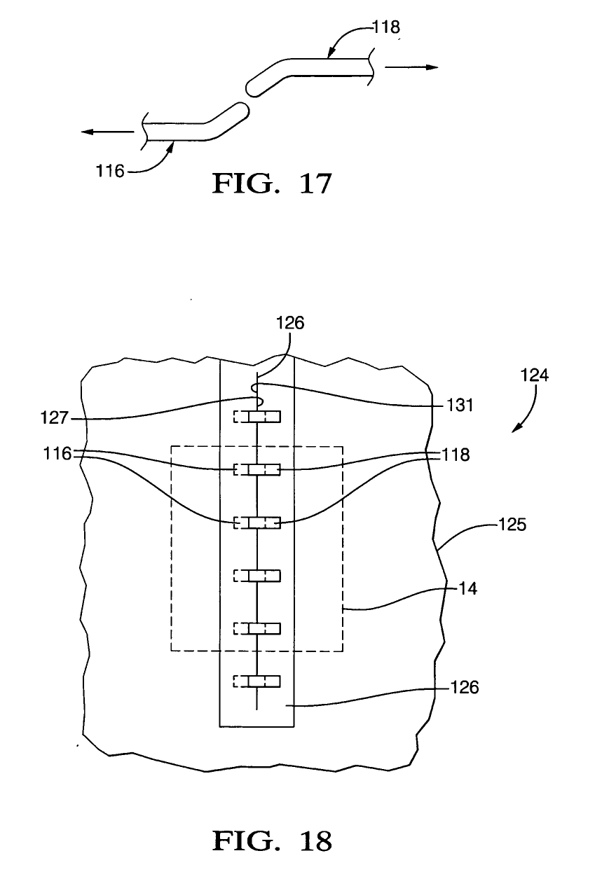

Referring to FIGS. 14, 15, 16, and 17, a seat cover 108 in accordance with another exemplary embodiment will now be described. The seat cover 108 includes a cover portion 109 having a seam or a slit 110 that extends through portion 109 proximate the air bag module 14. When the seam 110 is an open position, seam 110 defines a deployment opening for allowing the inflatable cushion 20 from the air bag module 14 to extend therethrough. In order to close the seam 110, the seat cover 108 includes first and second interlocking members. The first interlocking member comprises a plurality of hook portions 116 coupled to the portion 109 proximate a first edge 112. The second interlocking member comprises a plurality of hook portions 118 coupled to the portion 109 proximate a second edge 114. The plurality of hook portions 116 can be coupled to the corresponding plurality of hook portions 118 manually. Alternately, hook portions 116 and hook portions 118 could be coupled or interlocked together using automated equipment.

Each of the plurality of the hook portions 116 includes a shaft portion 119 and a C-shaped portion 120 coupled to the shaft portion 119. Similarly, each of the plurality of hook portions 118 includes a shaft portion 121 and a C-shaped portion 122 coupled to the shaft portion 121. Further, each of the C-shaped portions 122 can interlock with a corresponding C-shaped portion 120.

The plurality of hook portions 116 and a plurality of hook portions 118 are configured to disengage from one another when the inflatable cushion 20 from air bag control module 14 pushes against seam 110 during deployment of the inflatable cushion 20. In particular, when cushion 34 presses against seam 110 at a predetermined pressure during deployment of the inflatable cushion 20, the C-shaped portions 120 and 122 bend a sufficient amount such that each of the hook portions 116 separates from a corresponding hook portion 118. When the plurality of hook portions 116 and the plurality of hook portions 118 disengage from one another, the seam 110 defines a deployment opening that allows inflatable cushion 20 to pass therethrough. The plurality of hook portions 116 and the plurality of hook portions 118 can be constructed from one or more of aluminum, brass, steel, molded plastic, or nylon, for example.

Further, it should be noted that: (i) the number of both hook portions 116 and hook portions 118 can vary, (ii) the placement of both hook portions 116 and hook portions 118 on portion 109 can vary, and (iii) the size of the hook portions 116 and hook portions 118 can vary—depending upon the desired opening characteristics of the seam 110.

Referring to FIG. 18, a seat cover 124 in accordance with another exemplary embodiment will be described. The seat cover 124 is similar to the seat cover 108, except that the seat cover 124 includes a portion 126 for holding and supporting the hook portions 116 and hook portions 118. The portion 126 includes edges 127 and 132 that define a deployment opening for the inflatable cushion 20. Further, the portion 126 is stitched to a portion 125 of the seat cover 124.

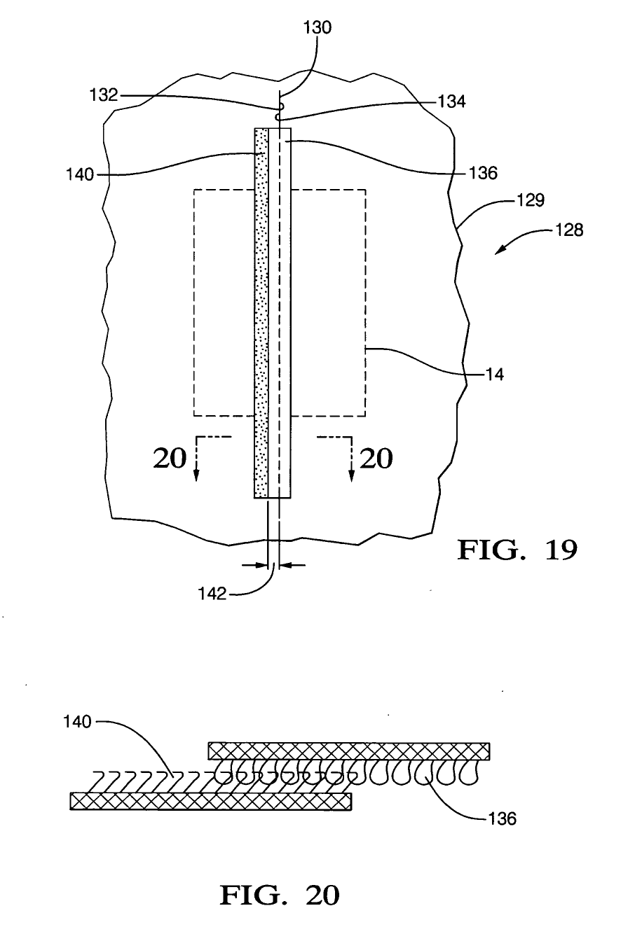

Referring to FIGS. 19 and 20, a seat cover 128 in accordance with another exemplary embodiment will now be described. The seat cover 128 includes a portion 129 having a seam or a slit 130 that extends through portion 129 proximate the air bag module 14. When the seam 130 is an open position, seam 130 defines a deployment opening for allowing the inflatable cushion 20 from the air bag module 14 to extend therethrough. In order to close the seam 130, the seat cover 128 includes first and second interlocking members. The first interlocking member comprises a plurality of hook portions 140 coupled to the portion 129 proximate a first edge 132. The second interlocking member comprises a plurality of the loop portions 136 coupled to the portion 129 proximate a second edge 134. The plurality of loop portions 136 can be coupled to the plurality of hook portions 140 manually.

The loop portions 136 and the hook portions 140 overlap one another and interlock with one another in a region 142. The loop portions 136 and the hook portions 140 can be implemented using a product having a trademark of Velcro. The plurality of loop portions 136 and the plurality of hook portions 140 are configured to disengage from one another when the inflatable cushion 20 from air bag control module 14 pushes against seam 130 during deployment of the inflatable cushion 20. In particular, when inflatable cushion 20 presses against seam 130 at a predetermined pressure, the loop portions 136 and the hook portions 140 separate from one another in the region 142. When loop portions 136 and the hook portions 140 disengage from one another, the seam 130 defines a deployment opening that allows inflatable cushion 20 to pass therethrough. It should be noted that: (i) the number of loop portions 136 and hook portions 140 can vary, (ii) the placement of the loop portions 136 and hook portions 140 on seat cover 128 can vary, and (iii) the size of the loop portions 136 and hook portions 140 can vary, based upon the desired opening characteristics of the seam 130.

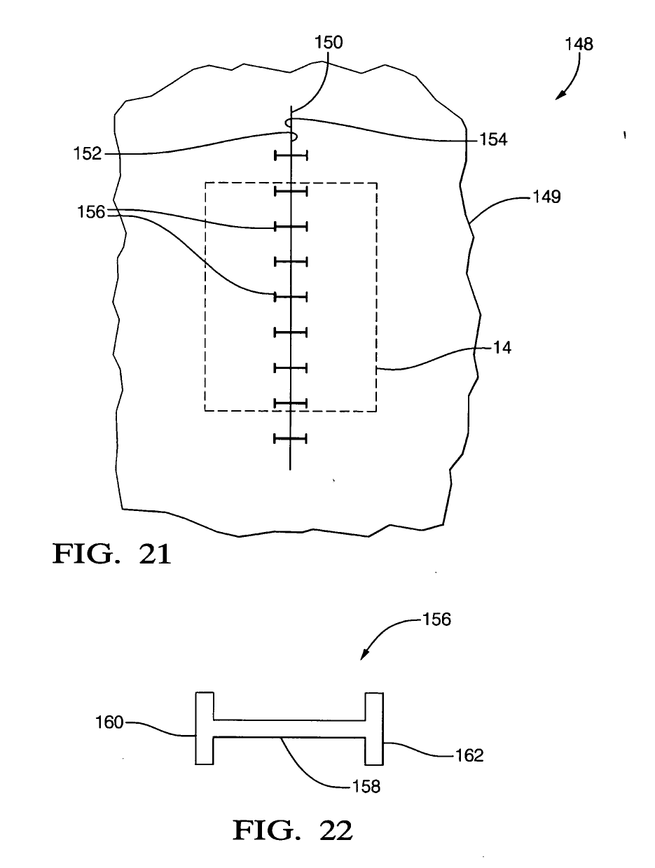

Referring to FIGS. 21 and 22, a seat cover 148 in accordance with another exemplary embodiment will now be described. The seat cover 148 includes a portion 149 having a seam or a slit 150 that extends through portion 149 proximate the air bag module 14. When the seam 150 is in an open position, seam 150 defines a deployment opening for allowing the inflatable cushion 20 from the air bag module 14 to extend therethrough. In order to close the seam 150, the seat cover 148 includes a plurality of plastic fasteners 156.

Each of the plastic fasteners 156 includes a shaft 158, an end portion 160, and an end portion 162. End portions 160 and 162 are disposed on opposite ends of shaft 158 and extend generally perpendicular to the shaft 158 to form an I-shaped plastic fastener.

Each of the plastic fasteners 156 are coupled across seam 150 and are attached to portion 149 proximate the first edge 152 and proximate the second edge 154 to close the seam 150. In particular, each end portion 160 is forced through the portion 149 proximate the first edge 152 using an insertion tool (not shown). Further, each end portion 162 is forced through portion 149 proximate the second edge 154 using the insertion tool. The plurality of plastic fasteners 156 can be manually affixed to portion 149. Alternately, plastic fasteners 156 can be affixed to portion 149 using automated equipment.

The plurality of plastic fasteners 156 are configured to break when the inflatable cushion 20 from air bag control module 14 pushes against seam 150 during deployment of the inflatable cushion 20. In particular, when inflatable cushion 20 presses against seam 150 at a predetermined pressure, the one or more of the plastic fasteners 156 breaks. When plastic fasteners 156 break, the seam 150 defines a deployment opening that allows inflatable cushion 20 to pass therethrough. It should be noted that: (i) the number of plastic fasteners 156 can vary, (ii) the placement of the fasteners 156 on seat cover 148 can vary, and (iii) the size of the plastic fasters 156 could vary—depending upon the desired opening characteristics of the seam 150.

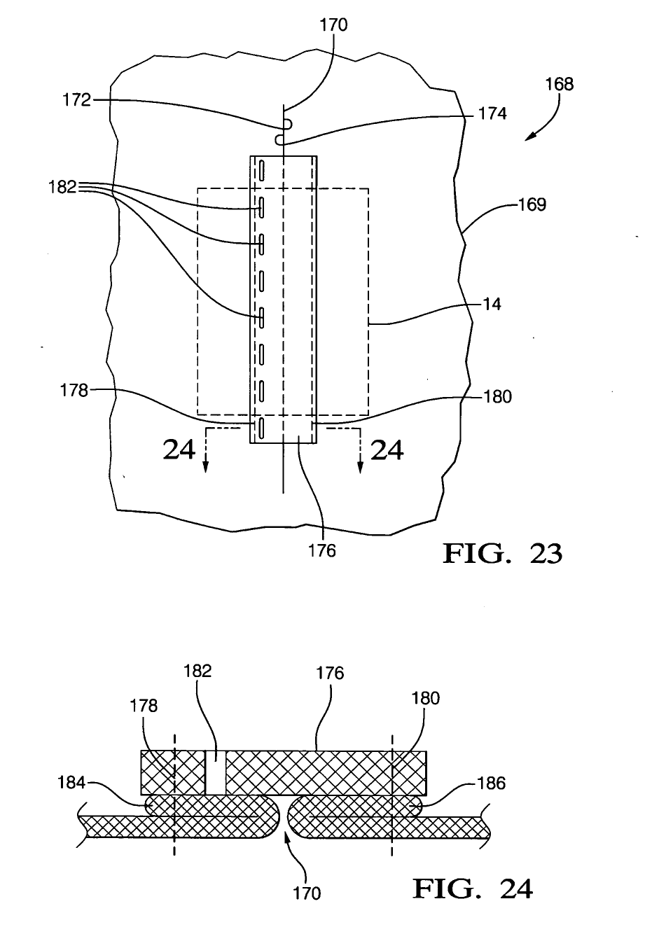

Referring to FIGS. 23 and 24, a seat cover 168 in accordance with another exemplary embodiment will now be described. The seat cover 168 includes a portion 169 having a seam or a slit 170 that extends through portion 169 proximate the air bag module 14. When the seam 170 is an open position, seam 170 defines a deployment opening for allowing the inflatable cushion 20 from the air bag module 14 to extend therethrough. In order to close the seam 170, the portion 169 further includes a plastic sheet 176.

The plastic sheet 176 is disposed over the seam 170 and stitched on opposite sides of the seam 170 to close seam 170. In particular, the portions 184, 186 of the portion 169 are folded over as shown in FIG. 24. Thereafter, the plastic sheet 176 is disposed over the seam 170 and the stitches 178 are stitched through the plastic sheet 176, the portion 184, and the portion 169 under portion 184. Further, stitches 180 are stitched through the plastic sheet 176, the portion 186, and the portion 169 under portion 186. Further, the plastic sheet 176 includes a plurality of apertures 182 extending through plastic sheet 176 that are disposed on sheet 176 generally parallel to the first edge 172. Further, the plurality of apertures 182 are offset a predetermined distance from the seam 170. In an alternate embodiment, the apertures 182 are disposed directly over the seam 170.

The plastic sheet 176 is configured to tear along the plurality of apertures 182 when the inflatable cushion 20 from air bag control module 14 pushes against seam 170 during deployment of the inflatable cushion 20. In particular, when inflatable cushion 20 presses against seam 170 at a predetermined pressure, the plastic sheet 176 tears along apertures 182. When the plastic sheet 176 tears, the seam 170 defines a deployment opening that allows the inflatable cushion 20 to pass therethrough. It should be noted that: (i) the thickness of the plastic sheet 176 can vary, (ii) the type of plastic used in the plastic sheet 176 can vary, and (iii) the number, shape, size and location of the apertures can vary—based upon the desired opening characteristics of the seam 170.

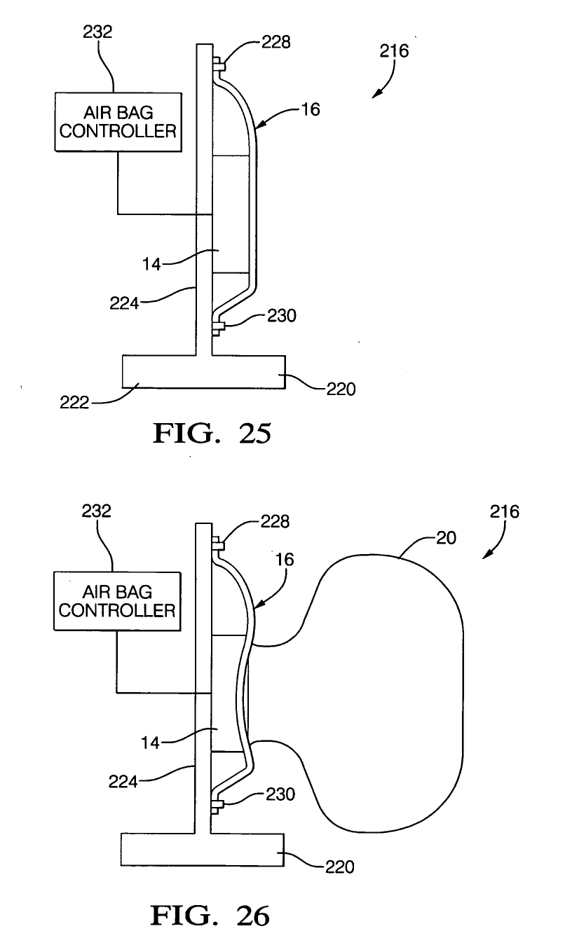

Referring to FIGS. 25 and 26, a system 216 for testing a seat cover in accordance with an exemplary embodiment is illustrated. In particular, the system 216 can be used to test any of the seat cover embodiments disclosed herein. For purposes of discussion, however, the seat cover 16 will be used to explain the operation of the system 216.

The system 216 includes a fixture 220, the air bag module 14, the seat cover 16, attachment means 228, 230, and an air bag controller 232.

The fixture 220 is provided to support the air bag module 14 and the seat cover 16. In particular, the air bag module 14 can be mounted on a vertical member 224 of the fixture 220 such that when an inflatable cushion 20 contained within the module 14 is deployed, the inflatable cushion 20 is deployed away from the vertical member 224. The seat cover 16 covers air bag module 14 and is attached to the fixture 220 at an upper portion using the attachment means 228. Further, the seat cover 16 is attached to the fixture 220 at a lower portion utilizing the attachment means 230. The attachment means 228, 230 can comprise any conventional type of fastener such as rivets, screws, and bolts, for example.

During testing of the seat cover 16, the air bag controller 232 can generate a control signal that causes an initiator (not shown) in the air bag module 14 to induce an inflation gas to be dispensed within the inflatable cushion 20. In response, the inflatable cushion 20 is deployed through a deployment opening of the seat cover 16.

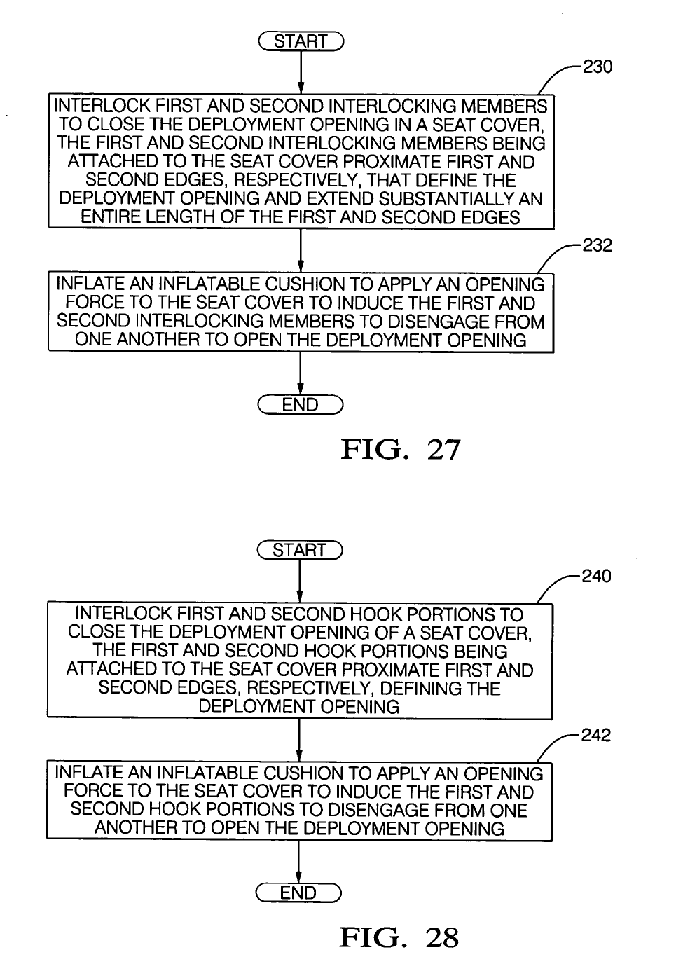

Referring to FIG. 27, a method for testing at least seat covers 16, 24, and 128 in accordance with another exemplary embodiment will now be explained. For purposes of simplicity, the method will be explained with respect to testing seat cover 16.

At step 230, the first and second interlocking members are interlocked to one another to close the deployment opening 52 in the seat cover 16, the first and second interlocking members being attached to the seat cover 16 proximate first and second edges 48, 50, respectively, that define the deployment opening 52 and extend substantially an entire length of the first and second edges 48, 50.

At step 232, the inflatable cushion 20 is inflated to apply an opening force to the seat cover 16 to induce the first and second interlocking members to disengage from one another to open the deployment opening 52.

Referring to FIG. 28, a method for testing at least seat covers 108 and 124 in accordance with another exemplary embodiment will now be explained. For purposes of simplicity, the method will be explained with respect to testing seat cover 108.

At step 240, the first and second hook portions 116, 118 are interlocked to one another to close the deployment opening of the seat cover 108, the first and second hook portions 116, 118 being attached to the seat cover 108 proximate first and second edges 112, 114, respectively, defining the deployment opening.

At step 242, the inflatable cushion 20 is inflated to apply an opening force to the seat cover 108 to induce the first and second hook portions 116, 118 to disengage from one another to open the deployment opening.

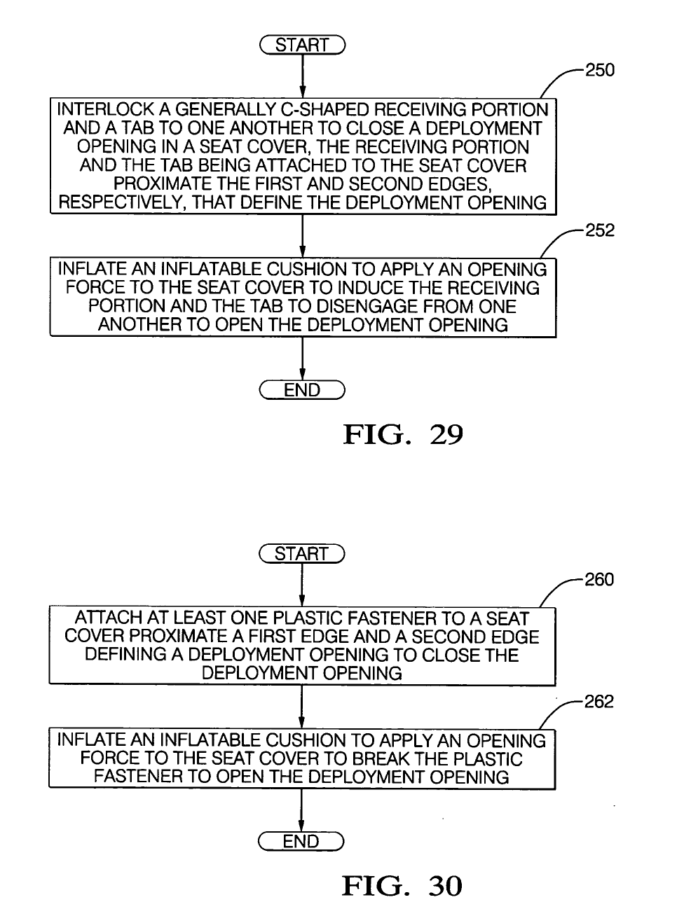

Referring to FIG. 29, a method for testing at least seat covers 58 and 103 in accordance with another exemplary embodiment will now be explained. For purposes of simplicity, the method will be explained with respect to testing seat cover 58.

At step 250, a generally C-shaped receiving portion and a tab are interlocked to one another to close a deployment opening in the seat cover 58, the receiving portion 66 and the tab 68 being attached to the seat cover 58 proximate the first and second edges 62, 64, respectively, that define the deployment opening.

At step 252, the inflatable cushion 20 is inflated to apply an opening force to the seat cover 58 to induce the receiving portion 66 and the tab 68 to disengage from one another to open the deployment opening.

Referring to FIG. 30, a method for testing at least seat covers 148 and 168 in accordance with another exemplary embodiment will now be explained. For purposes of simplicity, the method will be explained with respect to testing seat cover 148.

At step 260, at least one plastic fastener 156 is attached to the seat cover 148 proximate a first edge 152 and a second edge 154 defining a deployment opening to close the deployment opening.

At step 262, the inflatable cushion 20 is inflated to apply an opening force to the seat cover 20 to break the plastic fastener 156 to open the deployment opening.

It should be noted that the above-mentioned closing mechanisms for closing a deployment opening of a flexible enclosure, can be utilized on devices other than seats. For example, the closing mechanisms can be used to closing a deployment opening in a vehicle dashboard, a vehicle instrument panel, and A-pillar of a vehicle, or a B-pillar of a vehicle.

The vehicle seat embodiments disclosed herein represent a substantial advantage over known seats. In particular, each of the vehicle seat embodiments utilize first and second interlocking members to close a deployment opening of a seat cover. The first and second interlocking members can be utilized on various seat covers to provide a reliable deployment of an inflatable cushion relatively independent of the type of material of the seat cover. Further, by utilizing standardized first and second interlocking members to close deployment openings as disclosed herein, the amount of functional testing of inflatable cushion systems in the vehicle seats can be reduced.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed for carrying out this invention, but that the invention will include all embodiments falling within the scope of the appended claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

1. A vehicle seat, comprising:
an air bag module coupled to a vehicle seat frame, the air bag module having an inflatable cushion;
a seat cover configured to cover at least a portion of the air bag module, the seat cover having a deployment opening defining a first edge and a second edge adjacent the first edge; and
first and second interlocking members attached to the seat cover proximate the first and second edges, respectively, the first interlocking member configured to interlock with the second interlocking member to thereby close the deployment opening, the first and second interlocking members extending substantially an entire length of the first and second edges, the first and second interlocking members disengaging from one another upon deployment of the inflatable cushion to allow the inflatable cushion to pass through the deployment opening.

2. The vehicle seat of claim 1, wherein the first interlocking member includes at least one zipper tooth and the second interlocking member includes at least one zipper tooth.

3. The vehicle seat of claim 1, wherein the first interlocking member includes a plurality of flexible loops and the second interlocking member includes a plurality of flexible hooks configured to engage the flexible loops.

4. The vehicle seat of claim 1 wherein the seat cover covers substantially an entire vehicle seat frame.

5. The vehicle seat of claim 1, wherein the seat cover has a portion disposed in an aperture of the seat cover, and an outer periphery of the portion is fixedly attached to the seat cover, the portion being proximate the air bag module.

6. A vehicle seat, comprising:
an air bag module coupled to a vehicle seat frame, the air bag module having an inflatable cushion;
a seat cover configured to cover at least a portion of the air bag module, the seat cover having a deployment opening defining a first edge and a second edge adjacent the first edge; and
first and second interlocking members attached to the seat cover proximate the first and second edges, respectively, the first interlocking member having a first hook portion and the second interlocking member having a second hook portion, the first hook portion being configured to interlock with the second hook portion to thereby close the deployment opening, the first and second hook portions disengaging from one another upon deployment of the inflatable cushion to allow the inflatable cushion to pass through the deployment opening.

7. A vehicle seat, comprising:
an air bag module coupled to a vehicle seat frame, the air bag module having an inflatable cushion;
a seat cover configured to cover at least a portion of the air bag module, the seat cover having a deployment opening defining a first edge and a second edge adjacent the first edge; and
first and second interlocking members attached to the seat cover proximate the first and second edges, respectively, the first interlocking member having at least one generally C-shaped receiving portion and the second interlocking member having at least one tab configured to be received and held within an interior of the receiving portion to thereby close the deployment opening, the receiving portion and the tab disengaging from one another upon deployment of the inflatable cushion to allow the inflatable cushion to pass through the deployment opening.

8. The vehicle seat of claim 7, wherein the tab includes a shaft portion and a head portion coupled to the shaft portion, the head portion being received in the interior of the receiving portion.

9. The vehicle seat of claim 8, wherein the head portion of the tab is substantially barb-shaped.

10. A vehicle seat, comprising:
an air bag module coupled to a vehicle seat frame, the air bag module having an inflatable cushion;
a seat cover configured to cover at least a portion of the air bag module, the seat cover having a deployment opening defining a first edge and a second edge adjacent the first edge; and
at least one plastic fastener attached to the seat cover proximate the first edge and further attached to the seat cover proximate the second edge to close the deployment opening, the at least one plastic fastener breaking upon deployment of the inflatable cushion to allow the inflatable cushion to pass through the deployment opening.

11. The vehicle seat of claim 10, wherein the plastic fastener includes an elongated shaft, and first and second end portions coupled to opposite ends of the shaft, the first and second end portions extending generally perpendicular to the shaft.

12. The vehicle seat of claim 10, wherein the plastic fastener comprises a plastic sheet, the sheet being stitched to the seat cover proximate the first edge and further stitched to the seat cover proximate the second edge, the plastic sheet having at least one aperture extending therethrough.

13. A flexible enclosure, comprising:
a cover having a deployment opening defining a first edge and a second edge adjacent the first edge; and
first and second interlocking members attached to the cover proximate the first and second edges, respectively, the first interlocking member configured to interlock with the second interlocking member to thereby close the deployment opening of the cover, the first and second interlocking members extending substantially an entire length of the first and second edges, the first and second interlocking members disengaging from one another in response to an opening force being applied to the cover to open the deployment opening.

14. The flexible enclosure of claim 13, wherein the first interlocking member includes at least one zipper tooth and the second interlocking member includes at least one zipper tooth.

15. The flexible enclosure of claim 13, wherein the first interlocking member includes a plurality of flexible loops and the second interlocking member includes a plurality of flexible hooks configured to engage the flexible loops.

16. The flexible enclosure of claim 13, wherein the cover is configured to cover at least a portion of a vehicle seat.

17. The flexible enclosure of claim 13, wherein the opening force is applied generally perpendicular to a surface of the cover.

18. The flexible enclosure of claim 13, wherein the opening force is generated by an inflatable cushion being inflated proximate the cover.

19. A flexible enclosure, comprising:
a cover having a deployment opening defining a first edge and a second edge adjacent the first edge; and
first and second interlocking members attached to the cover proximate the first and second edges, respectively, the first interlocking member having a first hook portion and the second interlocking member having a second hook portion, the first hook portion being configured to interlock with the second hook portion to thereby close the deployment opening, the first and second hook portions disengaging from one another in response to an opening force being applied to the cover to open the deployment opening.

20. A flexible enclosure, comprising:
a cover having a deployment opening defining a first edge and a second edge adjacent the first edge; and
first and second interlocking members attached to the seat cover proximate the first and second edges, respectively, the first interlocking member having at least one generally C-shaped receiving portion and the second interlocking member having at least one tab configured to be received and held within an interior of the receiving portion to thereby close the deployment opening, the receiving portion and the tab disengaging from one another in response to an opening force being applied to the cover to open the deployment opening.

21. A flexible enclosure, comprising:
a cover having a deployment opening defining a first edge and a second edge adjacent the first edge; and
at least one plastic fastener attached to the cover proximate the first edge and further attached to the cover proximate the second edge to close the deployment opening of the cover, the at least one plastic fastener breaking in response to an opening force being applied to the cover to open the deployment opening.

22. The flexible enclosure of claim 21, wherein the plastic fastener includes an elongated shaft, and first and second end portions coupled to opposite ends of the shaft, the first and second end portions extending generally perpendicular to the shaft.

23. The flexible enclosure of claim 21, wherein the plastic fastener comprises a plastic sheet, the plastic sheet being stitched to the cover proximate the first edge and further stitched to the cover proximate the second edge, the plastic sheet having at least one aperture extending therethrough.

24. The flexible enclosure of claim 23, wherein the plastic sheet includes a plurality of apertures extending through the plastic sheet, the apertures being disposed on the sheet along an axis generally parallel to the first edge.

25. The flexible enclosure of claim 24, wherein each of the plurality of apertures are disposed a predetermined distance away from a seam defined by the first and second edges.

26. The flexible enclosure of claim 21, wherein the cover is configured to cover at least a portion of a vehicle seat.

27. The flexible enclosure of claim 21, wherein the opening force is applied generally perpendicular to a surface of the cover.

28. The flexible enclosure of claim 21, wherein the opening force is generated by an inflatable cushion being inflated proximate the cover.

29. A flexible enclosure comprising:
a cover having a deployment opening defining a first edge and a second edge adjacent the first edge; and
first and second fastening means attached to the cover proximate the first and second edges, respectively, for closing the deployment opening, the first and second fastening means extending substantially an entire length of the first and second edges, the first and second fastening means configured to engage one another when the inflatable cushion is in a non-inflated state, the first and second fastening means configured to disengage from one another in response to an opening force being applied to the cover to open the deployment opening.

30. A method for testing deployment of an inflatable cushion through a cover, the cover having a deployment opening defining a first edge and a second edge adjacent the first edge, comprising:
interlocking first and second interlocking members to one another to close the deployment opening, the first and second interlocking members being attached to the cover proximate the first and second edges, respectively, and extend substantially an entire length of the first and second edges; and
inflating the inflatable cushion to apply an opening force to the cover to induce the first and second interlocking members to disengage from one another to open the deployment opening.

31. A method for testing deployment of an inflatable cushion through a cover, the cover having a deployment opening defining a first edge and a second edge adjacent the first edge, comprising:
interlocking first and second hook portions to one another to close the deployment opening, the first and second hook portions being attached to the cover proximate the first and second edges, respectively; and
inflating the inflatable cushion to apply an opening force to the cover to induce the first and second interlocking members to disengage from one another to open the deployment opening.

32. A method for testing deployment of an inflatable cushion through a cover, the cover having a deployment opening defining a first edge and a second edge adjacent the first edge, comprising:
interlocking a generally C-shaped receiving portion and a tab to one another to close the deployment opening, the receiving portion and the tab being attached to the cover proximate the first and second edges, respectively; and
inflating the inflatable cushion to apply an opening force to the cover to induce the receiving portion and the tab to disengage from one another to open the deployment opening.

33. A method for testing deployment of an inflatable cushion through a cover, the cover having a deployment opening defining a first edge and a second edge adjacent the first edge, comprising:
attaching at least one plastic fastener to the cover proximate the first edge and to the cover proximate the second edge to close the deployment opening; and
inflating the inflatable cushion to apply an opening force to the cover to break the plastic fastener to open the deployment opening.
